(19) United States
(12) Patent Application Publication
(10) Pub. No.: US 2011/0225917 A1
(43) Pub. Date: Sep. 22, 2011

(54) Decorative architectural element and method for making

(76) Inventors: Jennifer Golden, Colon County, TX (US); Stephen J. Sexton, Collin County, TX (US)

(21) Appl. No.: 12/661,360

(22) Filed: Mar. 16, 2010

(51) Int. Cl. E06B 3/30; B29C 51/10; B29C 51/14; E06B 3/78

(52) U.S. Cl. 52/316; 156/245; 156/71

(57) ABSTRACT

A method for making a decorative architectural element is disclosed, which includes the steps of designing a vacuum form mold forming a three dimensional decorative shape for the architectural element, cut a moldable plastic sheet in a size and shape to fit over the vacuum form mold, designing a color graphic, print the color graphic onto a vinyl wrap which corresponds in size and shape to fit over the vacuum form mold covered with the plastic sheet, vacuum forming the plastic sheet over the vacuum form mold and the vinyl wrap over the plastic sheet. The plastic sheet takes the shape of the vacuum form mold and the vinyl wrap adheres to the molded plastic sheet. The molded plastic sheet and the attached molded vinyl wrap are then removed from the vacuum mold. One arrangement includes the step of affixing the molded plastic sheet with the attached molded vinyl wrap to the architectural element. The molded vinyl wrap faces away from the architectural element, so that the color graphic printed on the vinyl wrap is visible. A decorative architectural element includes a basic architectural element, a molded plastic sheet fitting over the basic architectural element giving the architectural element a decorative shape, and a molded vinyl wrap molded over the molded plastic and facing away from the basic architectural element. The molded vinyl wrap is printed with a color graphic.

### CROSS-REFERENCE TO RELATED APPLICATIONS

None

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to architectural elements and especially to creating decorative elements such as doors and door frames.

2. Description of Related Art

There have been many attempts of creating decorative doors. U.S. Pat. Nos. 4,316,345 and 6,684,589 show two such attempts. Published Patent Application 2003/0026940 shows a decorative door cover made of a sheet material.

U.S. Pat. No. 5,786,044 shows a three dimensional decorative door frame.

### BRIEF SUMMARY OF THE INVENTION

A method for making a decorative architectural element, according to the present invention, includes the steps of designing a vacuum form mold forming a three dimensional decorative shape for the architectural element, cut a moldable plastic sheet in a size and shape to fit over the vacuum form mold, designing a color graphic, print the color graphic onto a vinyl wrap which corresponds in size and shape to fit over the vacuum form mold covered with the plastic sheet, vacuum forming the plastic sheet over the vacuum form mold and the vinyl wrap over the plastic sheet. The plastic sheet takes the shape of the vacuum form mold and the vinyl wrap adheres to the molded plastic sheet. The molded plastic sheet and the attached molded vinyl wrap are then removed from the vacuum mold. For most situations, a high resolution color graphic is preferred. A typical thickness for the plastic sheet is from 1/32 inch to ½ inch, although other thicknesses may work.

A preferred method according to the present invention, further includes the step of affixing the molded plastic sheet with the attached molded vinyl wrap to the architectural element. The molded vinyl wrap faces away from the architectural element, so that the color graphic printed on the vinyl wrap is visible.

A method according to the present invention is especially well suited for when the decorative architectural element is a decorative door or a decorative door frame. The case of a decorative door frame further includes the step of removing the portions of the molded plastic sheet and the molded vinyl wrap which would cover the door. This method would also include the step of affixing the molded plastic sheet with the attached molded vinyl wrap to a door frame. The molded vinyl wrap faces away from the door frame, so that the color graphic printed on the vinyl wrap is visible.

A decorative architectural element, according to the present invention, includes a basic architectural element, a molded plastic sheet fitting over the basic architectural element giving the architectural element a decorative shape, and a molded vinyl wrap molded over the molded plastic and facing away from the basic architectural element. The molded vinyl wrap is printed with a color graphic. Such an architectural element could be a door, door frame, wainscoting, arches or other architectural elements.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a block diagram illustrating a method for making a decorative architectural element according to the present invention;

FIG. 2 is a diagrammatic illustration of part of the method of FIG. 1 for a door frame;

FIG. 3 is a diagrammatic illustration of part of the method of FIG. 1 for a door;

### DETAILED DESCRIPTION OF THE INVENTION

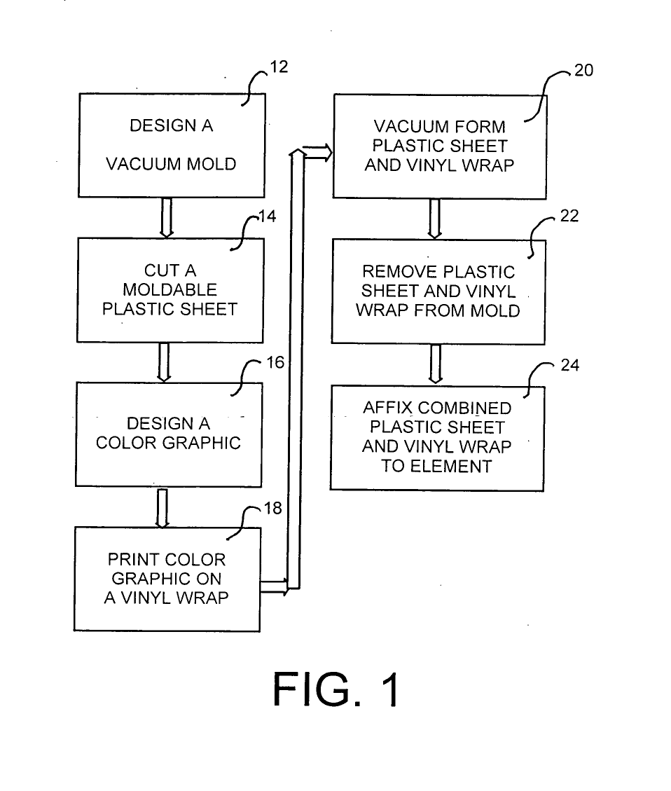

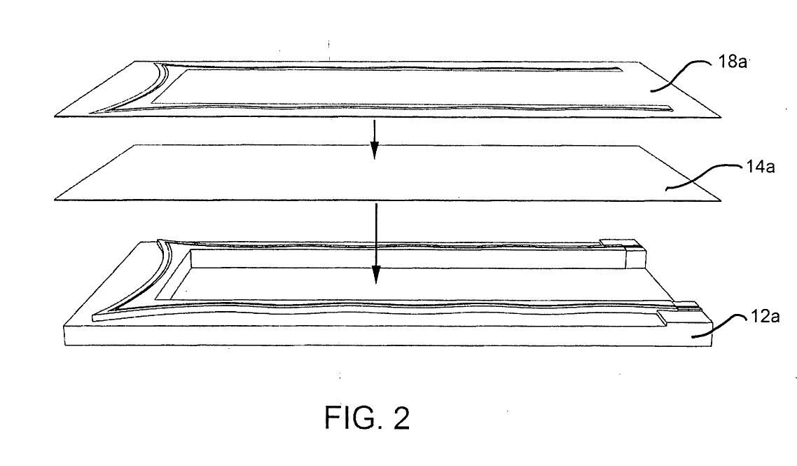

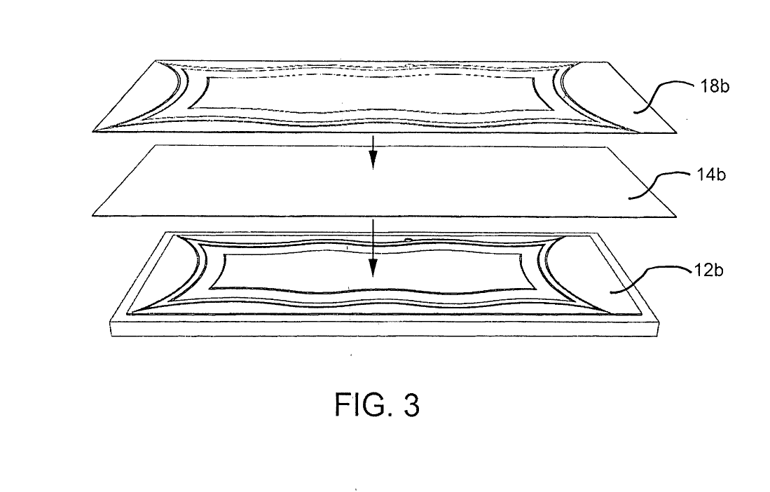

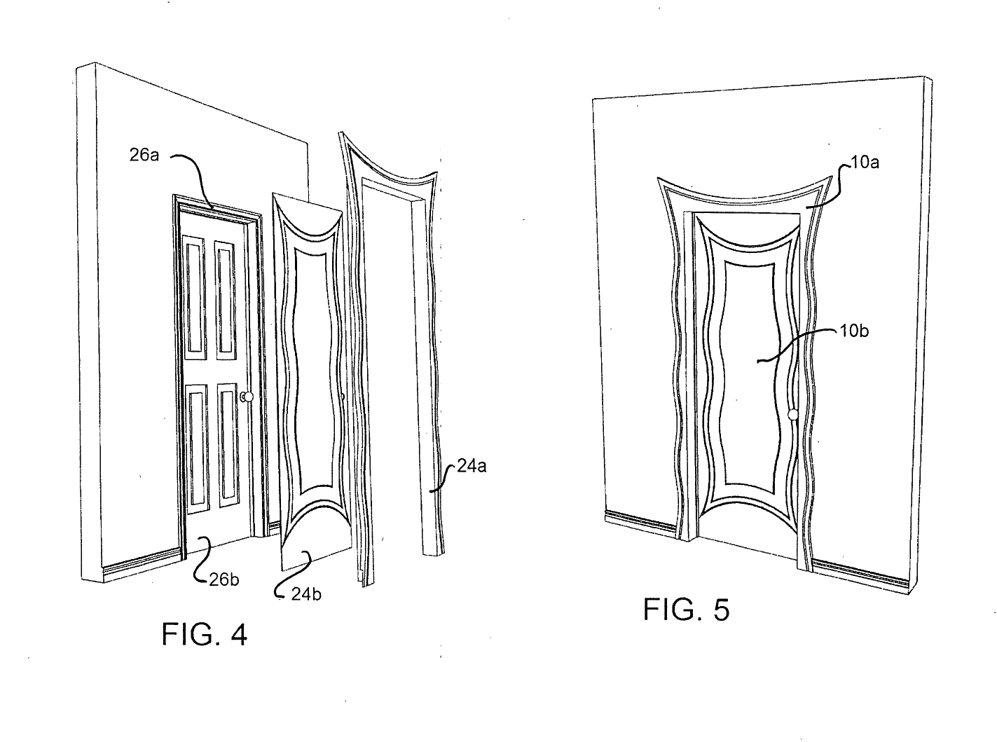

Referring now to the drawing, and in particular to FIG. 1, FIG. 2 and FIG. 3, a method for making a decorative architectural element, according to the present invention is referred to generally by reference numeral 10. Method 10 includes the steps of designing 12 a vacuum form mold 12a, 12b forming a three dimensional decorative shape for the architectural element, cut 14 a moldable plastic sheet 14a, 14b in a size and shape to fit over the vacuum form mold, designing 16 a color graphic, print 18 the color graphic onto a vinyl wrap 18a,18b which corresponds in size and shape to fit over the vacuum form mold covered with the plastic sheet, vacuum forming 20 the plastic sheet over the vacuum form mold and the vinyl wrap over the plastic sheet. The plastic sheet takes the shape of the vacuum form mold and the vinyl wrap adheres to the molded plastic sheet. The molded plastic sheet and the attached molded vinyl wrap are then removed 22 from the vacuum mold. As is clear from the Figures, the molded vinyl wrap does not completely wrap around the molded plastic sheet, but simply wraps itself around the outside of the molded part, the part which faces away from the architectural element when installed.

Referring also to FIG. 4 and FIG. 5, a preferred method according to the present invention, further includes the step of affixing 24 the combination 24a, 24b of molded plastic sheet with the attached molded vinyl wrap to the architectural element 26a, 26b. The molded vinyl wrap faces away from the architectural element, so that the color graphic printed on the vinyl wrap is visible. The affixing can be by adhesive, by screws or any other well known method for affixing. The affixing can also be permanent or temporary depending on the purpose of the decorative feature.

A method according to the present invention is especially well suited for when the decorative architectural element is a decorative door or a decorative door frame. The case of a decorative door frame further includes the step of removing the portions of the molded plastic sheet and the molded vinyl wrap which would cover the door. This method would also include the step of affixing the molded plastic sheet with the attached molded vinyl wrap to a door frame. The molded vinyl wrap faces away from the door frame, so that the color graphic printed on the vinyl wrap is visible.

A decorative architectural element 10a, 10b, according to the present invention, includes a basic architectural element 26a, 26b, a molded plastic sheet 14a, 14b fitting over the basic architectural element giving the architectural element a decorative shape, and a molded vinyl wrap 18a, 18b molded over the molded plastic and facing away from the basic architectural element. The molded vinyl wrap is printed with a color graphic. Such an architectural element could be a door, door frame, wainscoting, arches or other architectural elements.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A method for making a decorative architectural element, comprising in combination the steps of:
designing a vacuum form mold forming a three dimensional decorative shape for the architectural element;
cut a moldable plastic sheet in a size and shape to fit over the vacuum form mold;
designing a color graphic;
print the color graphic onto a vinyl wrap which corresponds in size and shape to fit over the vacuum form mold covered with the plastic sheet;
vacuum forming the plastic sheet over the vacuum form mold and the vinyl wrap over the plastic sheet, whereby the plastic sheet takes shape of the vacuum form mold and whereby the vinyl wrap adheres to the molded plastic sheet; and
removing the molded plastic sheet and the attached molded vinyl wrap from the vacuum mold.

2. A method according to claim 1, further comprising the step of affixing the molded plastic sheet with the attached molded vinyl wrap to the architectural element, wherein the molded vinyl wrap faces away from the architectural element, whereby the color graphic printed on the vinyl wrap is visible.

3. A method according to claim 1, wherein the decorative architectural element is a decorative door frame.

4. A method according to claim 3, further comprising the step of removing the portions of the molded plastic sheet and the molded vinyl wrap which would cover the door.

5. A method according to claim 4, further comprising the step of affixing the molded plastic sheet with the attached molded vinyl wrap to a door frame, wherein the molded vinyl wrap faces away from the door frame, whereby the color graphic printed on the vinyl wrap is visible.

6. A method according to claim 1, wherein the decorative architectural element is a decorative door.

7. A method according to claim 6, further comprising the step of affixing the molded plastic sheet with the attached molded vinyl wrap to a door, wherein the molded vinyl wrap faces away from the door frame, whereby the color graphic printed on the vinyl wrap is visible.

8. A decorative architectural element comprising in combination:
a basic architectural element;
a molded plastic sheet fitting over the basic architectural element giving the architectural element a decorative shape; and
a molded vinyl wrap molded over the molded plastic and facing away from the basic architectural element, wherein the molded vinyl wrap is printed with a color graphic.

9. A decorative architectural element according to claim 8 wherein the architectural element is a door.

10. A decorative architectural element according to claim 8 wherein the architectural element is a door frame.
